(19) United States
(12) Patent Application Publication
(10) Pub. No.: US 2018/0330858 A1
(43) Pub. Date: Nov. 15, 2018

(54) MAGNETIC ELEVATOR DRIVE MEMBER AND METHOD OF MANUFACTURE

(71) Applicant: OTIS ELEVATOR COMPANY, Farmington, CT (US)

(72) Inventors: Jagadeesh Kumar TANGUDU, South Windsor, CT (US); Michael A. KLECKA, Coventry, CT (US); Richard N. FARGO, Plainville, CT (US)

(21) Appl. No.: 15/595,089

(22) Filed: May 15, 2017

(51) Int. Cl. H01F 7/02; H01F 41/02; H01F 13/00

(52) U.S. Cl. CPC H01F 7/021; H01F 13/003; H01F 41/0253

(57) ABSTRACT

An illustrative example embodiment of a method of making a rotary magnetic drive member includes establishing a helical magnet on a rod using an additive manufacturing process.

### BACKGROUND

Elevator systems are in widespread use. The mechanism for propelling an elevator car may be hydraulic or traction-based. Modernization efforts have recently focused on replacing round steel ropes in traction-based systems with lighter weight belts, for example, and reducing the size of the machine components.

It has more recently been proposed to change elevator propulsion systems to include a magnetic drive. Linear and rotary magnetic drive arrangements are known in various contexts. It has recently been proposed to include a rotary magnetic arrangement for propelling an elevator car. One such arrangement is described in the United States Patent Application Publication No. US 2015/0307325. While such arrangements have potential benefits and advantages, implementing them on a commercial scale is not without challenges. For example, material and manufacturing costs could become prohibitively expensive. Another issue presented to those skilled in the art is how to realize an arrangement of components to ensure efficient and reliable operation.

### SUMMARY

An illustrative example embodiment of a method of making a rotary magnetic drive member includes establishing a helical magnet on a rod using an additive manufacturing process.

In an example embodiment having one or more features of the method of the previous paragraph, the additive manufacturing process comprises wire arc additive manufacturing.

In an example embodiment having one or more features of the method of any of the previous paragraphs, the helical magnet comprises a magnetic material and the rod comprises a non-magnetic material.

In an example embodiment having one or more features of the method of any of the previous paragraphs, the magnetic material comprises low carbon steel.

In an example embodiment having one or more features of the method of any of the previous paragraphs, the non-magnetic material comprises stainless steel.

In an example embodiment having one or more features of the method of any of the previous paragraphs, the additive manufacturing process comprises cold spray deposition.

In an example embodiment having one or more features of the method of any of the previous paragraphs, the additive manufacturing process comprises directed energy deposition.

In an example embodiment having one or more features of the method of any of the previous paragraphs, the helical magnet comprises a permanent magnet material.

In an example embodiment having one or more features of the method of any of the previous paragraphs, the helical magnet consists entirely of metal.

An example embodiment having one or more features of the method of any of the previous paragraphs includes establishing a pattern of magnetic poles on segments of the helical magnetic including like magnetic poles in axially adjacent segments of the helical magnet.

In an example embodiment having one or more features of the method of any of the previous paragraphs, establishing the pattern of magnetic poles comprises using an external exciter coil in combination with a capacitive charge that provides a short impulse magnetic field to magnetize in a required direction.

An illustrative example embodiment of a magnetic drive member includes a non-magnetic rod and a helical magnet comprising a plurality of turns supported on the non-magnetic rod with an axial spacing between axially adjacent segments of the helical magnet.

In an example embodiment having one or more features of the magnetic drive member of the previous paragraph, the rod comprises a hollow cylinder.

In an example embodiment having one or more features of the magnetic drive member of any of the previous paragraphs, the helical magnet comprises mild steel and the rod comprises stainless steel.

In an example embodiment having one or more features of the magnetic drive member of any of the previous paragraphs, the helical magnet is continuous and interrupted along a helical path along the rod.

In an example embodiment having one or more features of the magnetic drive member of any of the previous paragraphs, the helical magnet consists entirely of metal applied to the rod during an additive manufacturing process.

An example embodiment having one or more features of the magnetic drive member of any of the previous paragraphs includes a spacer between axially adjacent segments of the helical magnet, the spacer comprising a non-metallic material.

In an example embodiment having one or more features of the magnetic drive member of any of the previous paragraphs, the helical magnet comprises a plurality of segments having a selected magnetic pole pattern and segments with like poles are axially adjacent to each other.

In an example embodiment having one or more features of the magnetic drive member of any of the previous paragraphs, the helical magnet comprises a permanent magnet material.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system designed according to an embodiment of this invention.

FIG. 2 diagrammatically illustrates selected features of an example magnetic drive member designed according to an embodiment of this invention.

FIG. 3 schematically illustrates selected features of the embodiment of FIG. 2.

FIG. 4 schematically illustrates a method of manufacturing a magnetic drive member designed according to an embodiment of this invention.

### DETAILED DESCRIPTION

Example embodiments of this invention provide a magnetic screw or drive member for propelling an elevator car. Embodiments of a method of manufacturing such a magnetic drive member provide a cost-effective approach that results in an economical, effective and reliable magnetic drive member that is useful in an elevator system, for example.

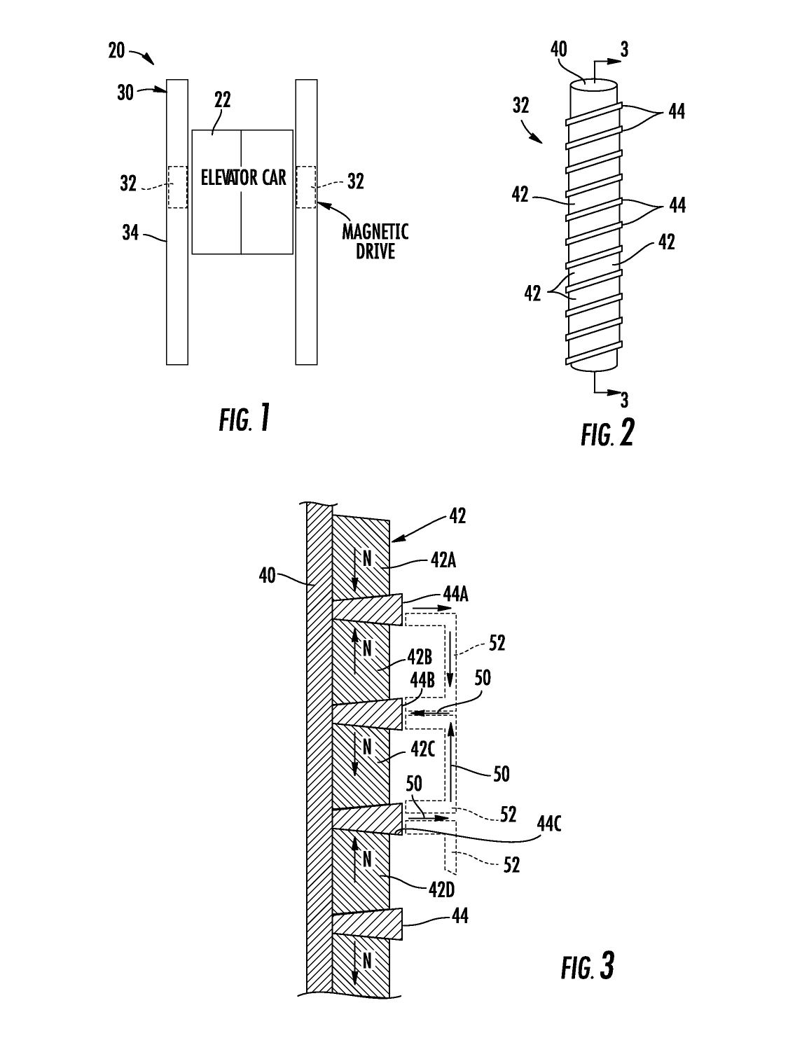

FIG. 1 schematically illustrates selected portions of an elevator system 20. An elevator car 22 is situated within a hoistway for vertical movement between landings, such as building levels. A magnetic drive arrangement 30 includes a rotary magnetic drive member 32 and a stationary magnetic drive member 34. In the illustrated example, the rotary magnetic drive member 32 is supported for movement with the elevator car 22 relative to the stationary member 34.

FIG. 1 schematically shows a ropeless elevator system. The magnetic drive arrangement 30 may be used instead of a hydraulic or traction-based elevator propulsion arrangement. Alternatively, the magnetic drive arrangement 30 may be used in a roped elevator system in which the elevator car 22 is coupled with a counterweight and the magnetic drive 30 provides the force for moving the elevator.

FIG. 2 illustrates an example embodiment of the magnetic drive member 32. In this embodiment, the drive member 32 may be considered a magnetic screw that can be rotated for purposes of interacting with cooperative features of the magnetic drive arrangement 30 to cause desired movement of the elevator car 22. The magnetic drive member 32 in this example comprises a rod 40 made of a non-magnetic material. In the illustrated example, the rod 40 comprises a hollow cylinder. In one example, the rod comprises an austenitic stainless steel. Other non-magnetic materials may be used to meet the needs of a particular situation. A variety of rod configurations may be used in different embodiments.

A helical magnet 42 is situated on and secured to the rod 40. A helical spacer 44 is situated within spacing between axially adjacent turns of the helical magnet 42.

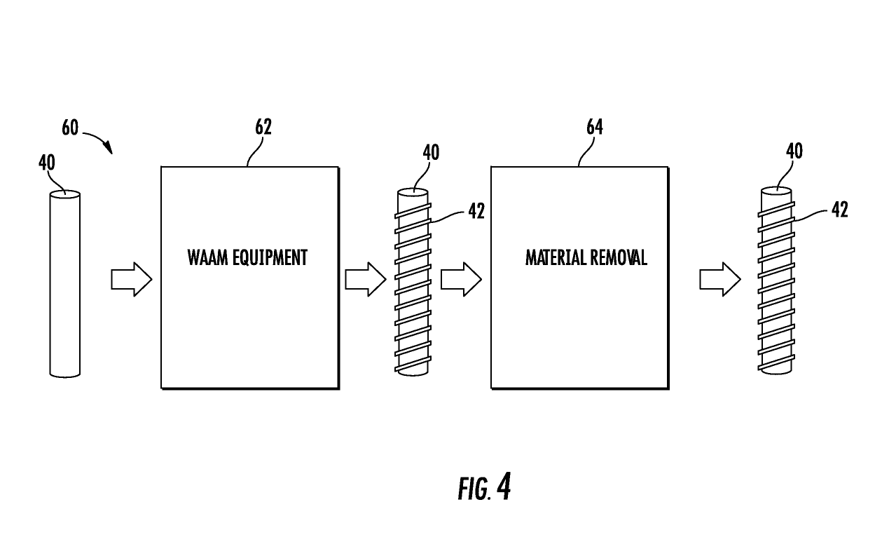

The turns of the magnet 42 are magnetically configured to have alternating pole directions as schematically shown in FIG. 3. Oppositely oriented poles of axially adjacent segments of the helical magnet 42 face toward a portion or segment of the spacer 44 between those segments of the magnet 42. For example, a first pole segment 42A of the helical magnet 42 faces a second pole segment 42B. Additional pole segments 42C and 42D of the helical magnet 42 face each other. Such an arrangement of magnetically oriented segments of the magnet 42 is repeated along the length of the magnetic drive member 32.

With the magnetic poles arranged as schematically shown in FIG. 3, a plurality of magnetic flux paths are established along the length of the magnetic drive member 32 for interacting with a correspondingly configured stator or stationary magnetic drive member of the magnetic drive 30 to cause movement of the elevator car 22 in a vertical direction. An example flux path is shown at 50 where magnetic flux emanates outward from one segment 44A of the spacer between the north pole segments 42A and 42B, through an appropriate portion of the stationary magnetic drive member 34, such as a metallic tooth as schematically illustrated in phantom at 52, and back toward a portion or segment 44B of the spacer 44 between the segments 42B and 42C of the helical magnet 42. Additional magnetic flux flows through a segment 44C of the spacer 44 from between magnet segments 42C and 42D, through a tooth 52 of the stationary portion of the magnetic drive 30, and back toward the rod 40 through the spacer segment 44B. Although not illustrated, there will be leakage flux between the spacer segment 44A and the magnet 42 B and from the spacer segment 44B to the magnet 42B, for example.

Given that the operation of linear and rotary magnetic drives is generally known, no further explanation need be provided within this description regarding how magnetic flux and rotary motion results in a linear or vertical movement.

FIG. 4 schematically illustrates an example process 60 for making a magnetic drive member designed according to an embodiment of this invention. Additive manufacturing equipment 62 is utilized for establishing the helical magnet 42 on the rod 40. In the illustrated example, the helical magnet 42 is established using a wire arc additive manufacturing technique, an additive friction stir manufacturing technique, or a wire feed additive manufacturing technique. Such techniques are generally known. Other example additive manufacturing techniques that are used in some embodiments include cold spray and laser or directed energy deposition techniques, which may be used with wire or base material in a powder form, Big Area Additive Manufacturing (BAAM), Direct write, etc. Embodiments that include cold spray additive manufacturing include the potential to avoid disrupting or removing desired phases and microstructures in the material because the powder is not melted and such characteristics could be removed during melting.

In the example of FIG. 4, after the additive manufacturing, at least some of the material that was added by the additive manufacturing equipment 62 is removed by material removal equipment schematically shown at 64. One example includes turning the rod 40 on a lathe for removing a portion of the material of the magnet that was added to the rod 40 by the additive manufacturing process. The removal equipment 64 may be configured, for example, to establish a desired cross-section of the helical magnet 42. In other embodiments the additive manufacturing process results in a desired configuration or cross-section of the helical magnet 42 and no material removal is required.

The spacer 44 in some embodiments is added to or incorporated as part of the rod 40 prior to the helical magnet 42 being formed on the rod 40. In other embodiments the spacer 44 is formed using an additive manufacturing process, which can be completed after the helical magnet 42 is established.

One feature of the additive manufacturing technique included in the example embodiment is that it allows for using a non-magnetic material for the rod 40 and a magnetic material for the helical magnet 42. Additive manufacturing techniques, such as those mentioned above, allow for joining dissimilar materials in a way that results in a sufficiently robust arrangement of the helical magnet 42 on the rod 40 to withstand the forces involved in operating the elevator drive arrangement 30. In an example embodiment, the helical magnet 42 comprises a permanent magnet material, the spacers 44 comprise a mild steel, and the rod 40 comprises a non-magnetic metal, such as stainless steel. Example permanent magnet materials include rare earth permanent magnets such as sintered Nd2Fe14B; sintered SmCo5; sintered Sm(Co,Fe,Cu,Zr)7; bonded Nd2Fe14B; sintered alloys comprising aluminum, nickel and cobalt; or non-rare earth magnets such as Manganese Bismuth, and sintered M-type hexagonal ferrites (e.g., Sr-Ferrite).

The additive manufacturing equipment 62 allows for specific control over the configuration and size of the helical magnet 42. In one example, the rod 40 has a 50 mm or two inch outer diameter. The helical magnet 42 has a height of approximately 15 mm or one-half inch (extending radially outward from the outer surface of the rod 40) with a 25 mm or one inch spacing between axially adjacent turns of the helical magnet 42. Other dimensions are useful for some elevator drive arrangements.

The additive manufacturing used in the illustrated embodiment can be considered metal additive manufacturing because the material of the helical magnet 42 consists of only metal. Additively manufacturing the helical magnet 42 without including any polymer provides a more consistent magnetic path and a stronger magnet. In embodiments that include polymers or other materials within the magnet 42, the magnetic path would be at least partially interrupted by such material and the magnet would have to be larger in size to achieve a corresponding magnetic strength to a smaller sized all-metal magnet.

The helical magnet 42 is continuous and uninterrupted along the length of the helix. This configuration is superior to an arrangement of individual magnets situated next to each other along a helical or spiraled path. Individual magnets introduce leakage flux between adjacent magnets, additional harmonics and losses within the magnetic drive 30 that reduce effective thrust and cause noise and vibration.

The magnet 42 is magnetized in some example embodiments by applying a magnetic field during the additive manufacturing process to align the particles of the magnet material for achieving a configuration of pole orientation like that shown in FIG. 3, for example. Additional magnetization may be accomplished once the additive manufacturing is complete by using an external exciter coil in combination with capacitive charge that would provide short impulse magnetic field to magnetize in the required direction (e.g., for a north pole). The direction of the current can be changed to the opposite direction to alter the magnetization direction (e.g., for a south pole) in the adjacent magnet. The span of this magnetizing coil can either cover one full helical structure or a portion of the structure and the component 32 will be moved vertically and circumferentially to align the next helical magnet portion with the magnetizer coil to magnetize the next helical portion. Therefore, the exciter coil in such an embodiment can be used to magnetize only a portion of the helical magnet at a time.

In some embodiments, the spacers 44 are not included throughout the gap between all turns of the helical magnet 42. In spaces not occupied by spacers 44, magnetizing hardware configured to fit within the gap facilitates magnetizing the permanent magnet 42. In some examples, after such magnetization, additional spacers 44 are included in gaps that were used for accommodating the magnetizing hardware.

The example disclosed magnetic drive member 32 has increased magnetic efficiency compared to prior arrangements, which allows for using a smaller sized drive member, reducing the cost of the magnetic drive system and reducing the amount of space required within an elevator hoistway for the magnetic drive.

One feature of using a single, continuous helical magnet 42 as included in the illustrated embodiment is that it reduces any requirement for wrapping the magnetic drive member 32 in carbon fiber as would otherwise be needed for retaining individual magnets in place along the helical path occupied by the helical magnet 42. One drawback to using such a wrap in some previous rotary magnetic drive arrangements is the added effective air gap introduced by the wrap, which reduces the magnetic effectiveness of the system and potentially introduces variation of flux levels between magnet segments. Instead, embodiments of this invention include a helical magnet 42 bonded to a rod in a manner that does not require a carbon fiber wrap even for high speed applications. The helical magnet 42 and the spacer 44 establish an improved magnetic circuit even in embodiments that are intended for higher rotational speeds.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of making a rotary magnetic drive member, the method comprising:
establishing a helical magnet on a rod using an additive manufacturing process.

2. The method of claim 1, wherein the additive manufacturing process comprises wire arc additive manufacturing.

3. The method of claim 1, wherein the helical magnet comprises a magnetic material and the rod comprises a non-magnetic material.

4. The method of claim 3, wherein the magnetic material comprises low carbon steel.

5. The method of claim 3, wherein the non-magnetic material comprises stainless steel.

6. The method of claim 1, wherein the additive manufacturing process comprises cold spray deposition.

7. The method of claim 1, wherein the additive manufacturing process comprises directed energy deposition.

8. The method of claim 1, wherein the helical magnet comprises a permanent magnet material.

9. The method of claim 1, wherein the helical magnet consists entirely of metal.

10. The method of claim 1, comprising establishing a pattern of magnetic poles on segments of the helical magnetic including like magnetic poles in axially adjacent segments of the helical magnet.

11. The method of claim 10, wherein establishing the pattern of magnetic poles comprises using an external exciter coil in combination with a capacitive charge that provides a short impulse magnetic field to magnetize in a required direction.

12. A magnetic drive member, comprising:
a non-magnetic rod; and
a helical magnet comprising a plurality of turns supported on the non-magnetic rod with an axial spacing between axially adjacent segments of the helical magnet.

13. The magnetic drive member of claim 12, wherein the rod comprises a hollow cylinder.

14. The magnetic drive member of claim 12, wherein
the helical magnet comprises mild steel; and
the rod comprises stainless steel.

15. The magnetic drive member of claim 12, wherein the helical magnet is continuous and interrupted along a helical path along the rod.

16. The magnetic drive member of claim 12, wherein the helical magnet consists entirely of metal applied to the rod during an additive manufacturing process.

17. The magnetic drive member of claim 12, comprising a spacer between axially adjacent segments of the helical magnet, the spacer comprising a non-metallic material.

18. The magnetic drive member of claim 12, wherein
the helical magnet comprises a plurality of segments having a selected magnetic pole pattern; and
segments with like poles are axially adjacent to each other.

19. The magnetic drive member of claim 12, wherein the helical magnet comprises a permanent magnet material.
